(19) United States
(12) Patent Application Publication
(10) Pub. No.: US 2005/0201716 A1
(43) Pub. Date: Sep. 15, 2005

(54) Transmitter for light barriers, light grids and the like

(75) Inventor: Martin Wuestefeld, Sexau (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch (DE)

(21) Appl. No.: 11/076,468

(22) Filed: Mar. 8, 2005

(30) Foreign Application Priority Data
Mar. 11, 2004 (DE) 102004011911.2

(51) Int. Cl. G02B 6/00

(52) U.S. Cl. 385/147

(57) ABSTRACT

A transmitting element for light barriers, light grids and the like has a light source preferably configured as a semiconductor element, whose light-emitting surface has linear dimensions of less than 500 μm. In front of the light-emitting surface of the light source, at a distance of at least 5 mm, is a pin-hole diaphragm with an aperture of a diameter of less than 3 mm. The transmitting element is covered by a transparent front glass pane.

### BACKGROUND OF THE INVENTION

The invention concerns a transmitting element for light barriers, light grids and the like which has a light source and optics for focusing the light emitted by the light source.

Light barriers, light grids and the like make use of transmitting elements which emit a directional light beam, typically infrared light, that is directed onto an associated receiving element. In a light barrier, one or a few transmitting elements and associated receiving elements are used. Light grids have a greater number of such transmitting elements and receiving elements which are arranged in a strip.

To generate a directional light beam, light emitted from a light source is focused with an optical lens. It is also known to use light-emitting diodes (LED), which have a spherical lens or an integrated reflector, as the light source. It is further known to use laser diodes and particularly VCSEL diodes (Vertical Cavity Surface Emitting Laser diodes), which emit light that has a limited directional angle. Both LED light sources with integrated optical components and laser diodes or VCSEL diodes, however, have only limited use in safety engineering. The main reason for this is that the required critical angle of divergence of the beam cannot be adequately maintained. When the angular divergence control requirements are high, such as for light grids of safety category 4, which have an absolute critical angle less than 5°, the relatively expensive combination of a light source and an optical lens must be used.

### SUMMARY OF THE INVENTION

It is therefore an object of the present invention to provide an economical transmitting element for light barriers, light grids and the like that fulfills the rather stringent requirements for limiting the critical angles of divergence of the emitted light.

This object is attained according to the present invention with a transmitting element which uses a light source that emits light with a relatively small angle of divergence and by placing a pin-hole diaphragm relatively closely adjacent to the light-emitting surface of the light source.

An important feature of the invention is to provide the light source with a light-emitting surface that has small linear dimensions and placing a pin-hole diaphragm with a small-hole diameter in front of this light-emitting surface. The linear dimensions of the aperture in the pin-hole diaphragm are less than 3 mm. The diaphragm is placed at least 5 mm from the emitting surface.

The divergence of the light emitted by the transmitting element is primarily limited by the geometry of the arrangement, i.e. by the size (small) diameter of the aperture in the pin-hole diaphragm, and the distance of the diaphragm from the light-emitting surface. It is necessary to select relatively small dimensions for the light-emitting surface, since larger dimensions of the emitting surface increase the light beam divergence. The usually undesirable diffraction of light by small pin-holes is taken advantage of by the present invention because such diffraction of the light results in a more uniform illumination at the far region of the light beam.

In a preferred embodiment, the front (emitting) side of the transmitting element is covered by a transparent front glass pane. It protects the light source and especially the pin-hole diaphragm from getting soiled, smudged or otherwise degraded or damaged. Since there is no optical imaging with lenses, distance adjustments within the transmitting element as well as between the transmitting element and the receiving element are not critical. Because of the fact that the light is diffracted by the small aperture in the pin-hole diaphragm, there is also less impairment of the light transparency of the front glass pane by scratches, dust, lint and the like, so that the beam quality and the illumination of the beam cross-section at the receiving element are less affected. It is also advantageous that no optical imaging occurs, so that smudges on the front glass pane are not projected onto the receiver.

The linear dimensions of the emitting surface of the light source are less than 500 μm, and the emitting surface can be, for example, a rectangle with this side length. A beam of more limited light divergence results from smaller emitting surface dimensions, such as only 400 μm and, preferably, even less than 200 μm. Smaller emitting surface dimensions require light sources of sufficient power.

The pin-hole diaphragm is preferably a circular diaphragm with an aperture of a diameter that is less than 3 mm. Here as well, decreasing the aperture diameter results in less beam divergence. Thus, in one embodiment of the invention, the aperture has a diameter of about 1.5 mm, which is advantageous.

The distance of the pin-hole diaphragm from the light-emitting surface also influences the light beam divergence. Increasing this distance reduces the beam divergence. However, larger distances lessen the amount of light that impinges on the receiving element and increase the structural dimensions of the transmitting element in the beam direction. The distance is preferably not more than 40 mm. More preferred is a distance between about 10 mm and 30 mm, and particularly about 20 mm.

Semiconductor elements are especially suitable for use as the light source. If an LED is used as the light source, the restriction of a light beam by the pin-hole diaphragm involves a heavy loss of the light quantity directed at the light receiver. It is therefore preferable to use laser diodes and especially VCSEL diodes which emit relatively directional radiation.

The semiconductor elements serving as the light source are preferably mounted as a chip on one wall of the housing of the light barrier or light grid, so that a direct thermal coupling to the housing is possible. This is of advantage when using light sources having high power. The chips can then be used in the chip-on-board technique (COB) or the chip-on-film technique (COF).

In another embodiment of the invention, a further, second pin-hole diaphragm is arranged between the light source and the first pin-hole diaphragm. In this manner, neighboring beams of a light grid are readily kept separated from each other.

Due to geometrical limits on the beam divergence, the transmitting element of the present invention is primarily intended for light barriers and light grids of limited range, e.g. up to about 4 m.

Thus, the present invention provides a light grid that is very economical to produce because there is no optical imaging and the elements that would be required for imaging, such as lenses and the like, are not needed. This renders the system of the present invention relatively insensitive to its positioning and, therefore, it also is correspondingly easy to align.

### BRIEF DESCRIPTION OF THE DRAWINGS

FIG. 1 schematically shows a transmitting element of the present invention;

FIG. 2 shows the distribution of the light intensity of a VCSEL diode used in a prior art transmitting element without a pin-hole diaphragm;

FIG. 3 shows the intensity distribution of the light for a transmitting element made according to the present invention at a point relatively far away from the light source;

FIG. 4 shows the influence of defects in the front glass pane of the transmitting element on the light intensity distribution in a relatively distant point; and

FIG. 5 shows an embodiment of the transmitting element of the present invention for use in a light grid.

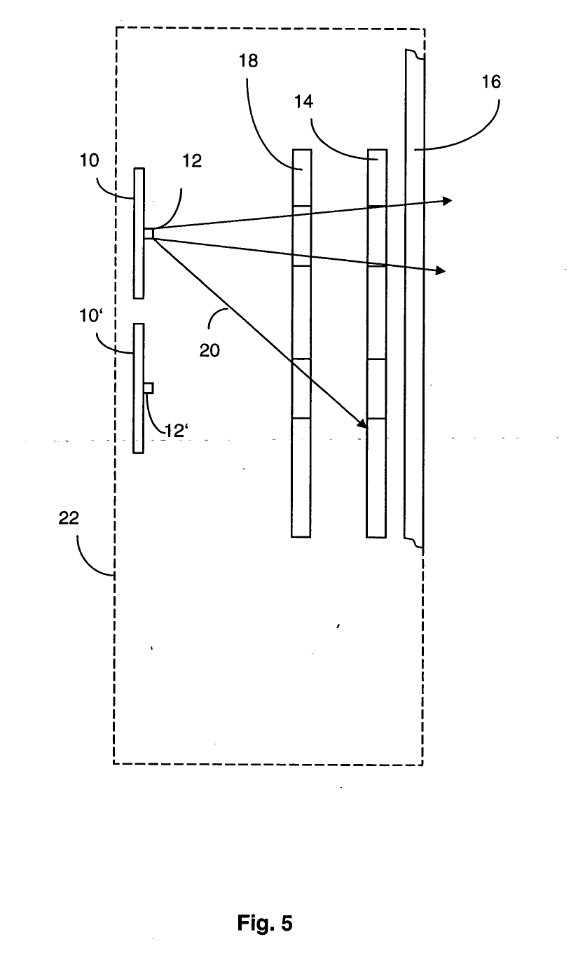

### DESCRIPTION OF THE PREFERRED EMBODIMENTS

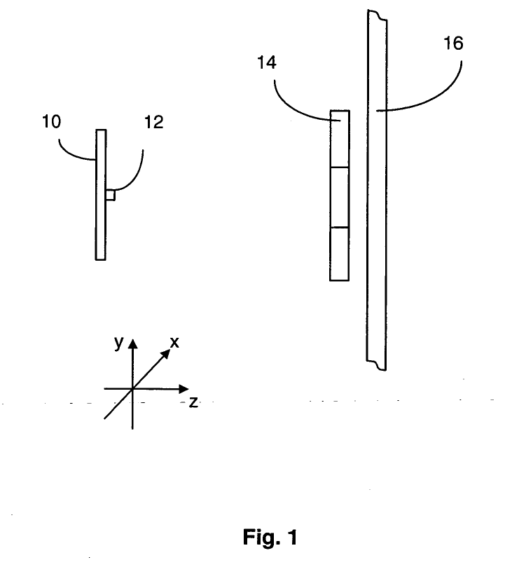

FIG. 1 shows a schematic layout of the transmitting element of the present invention. A light source 12, in the form of a light-emitting semiconductor element, preferably a VCSEL diode, is arranged on a chip 10. A light-emitting surface of light source 12 has the shape of a rectangle with side lengths of less than 500 μm. A pin-hole diaphragm 14 is spaced from the VCSEL diode light source 12 at least about 5 mm in the radiating direction (Z-axis). The pin-hole diaphragm 14 has a circular aperture with a diameter of less than 3 mm. In the beam exit direction, the transmitting element is covered by a transparent glass pane 16 positioned in front of the diaphragm.

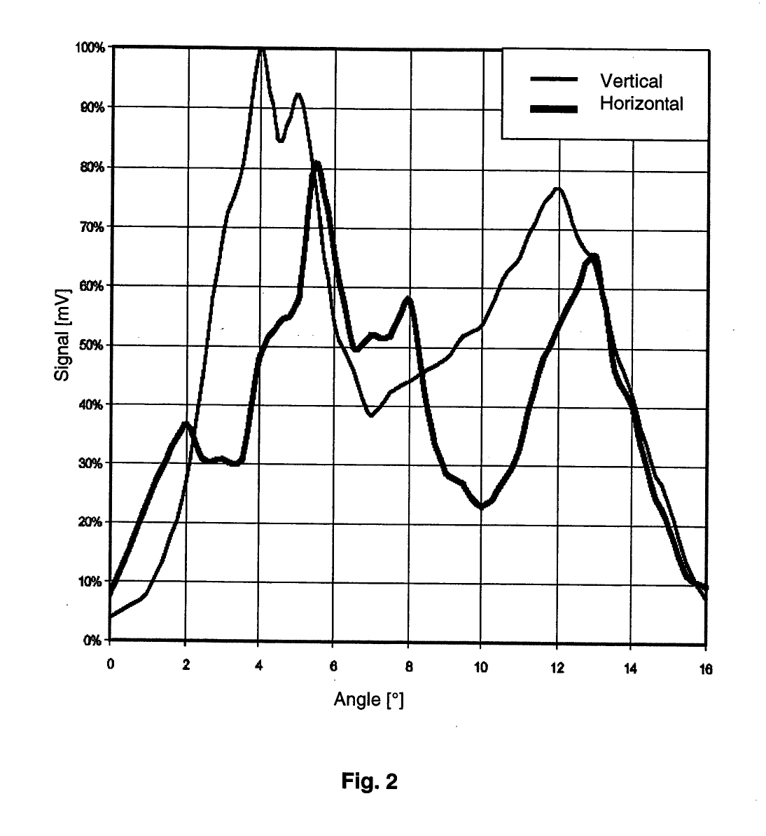

FIG. 2 plots the angular distribution of the relative light intensity of a VCSEL diode light source 12, used without a pin-hole diaphragm as in the prior art, at a distance of 3 m from the light source. The distribution is plotted across the diameter of the light beam in a vertical direction (Y-axis in FIG. 1) and in a horizontal direction (X-axis in FIG. 1). It shows that there is an angular divergence of the beam of ±8° and a non-uniform illumination.

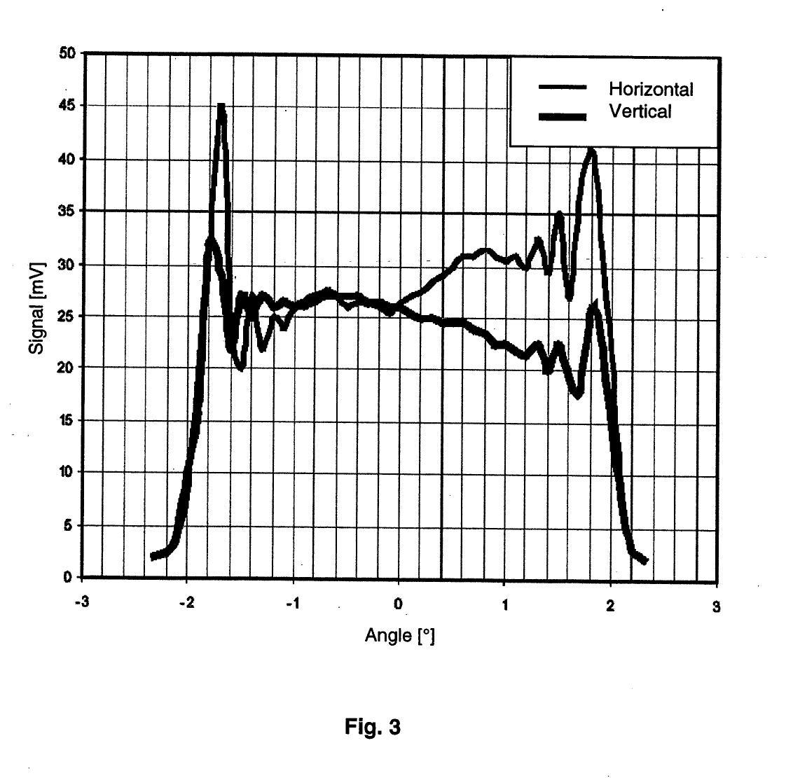

FIG. 3 plots the corresponding intensity distribution of the light beam at 3 m from the same light source 12, but fitted with a pin-hole diaphragm 14 in accordance with the present invention, which has a circular aperture with a diameter of 1.5 mm and which is placed at a distance of 20 mm in front of the light source. It is immediately evident that the beam divergence is substantially less than in the prior art arrangement and amounts to only ±2°. Further, due to the diffraction of the light at the margins of the aperture in the pin diaphragm 14, the intensity distribution is substantially more uniform; i.e. the surface of a receiving element is illuminated more uniformly than is possible with the prior art arrangement, resulting in the non-uniform light distribution shown in FIG. 1.

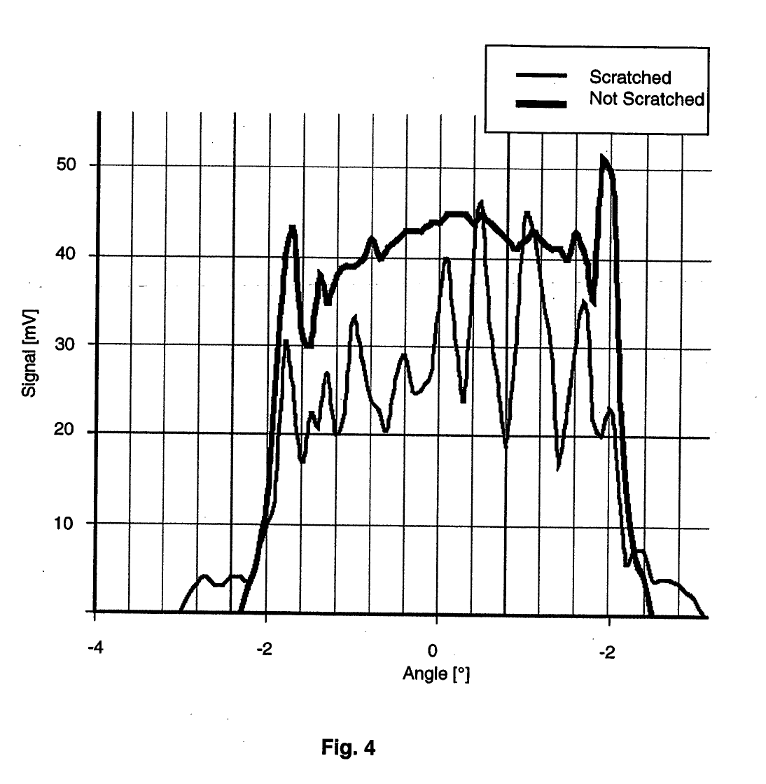

FIG. 4 shows the influence of defects on front glass pane 16 for the same transmitting element as was used for plotting the curves of FIG. 3.

FIG. 4 shows the angle-dependent intensity distribution of the light at a distance of 3 m from the light source. The bolded curve shows the intensity distribution for an undamaged front glass pane 16, while the thin curve shows the intensity distribution for a front glass pane 16 that was heavily scratched. Although the scratches and damage to the front glass pane 16 cause a reduction in the light intensity, the beam divergence is almost unchanged and the angular distribution of the luminous intensity is also only slightly impaired.

In another embodiment of the invention, an additional, second pin-hole diaphragm 18 is arranged on a bar 22 of the transmitting element for a light grid between each light source 12 and 12′ and each pin-hole diaphragm 14, which has apertures that are aligned with those of the first pin-hole diaphragm 14. The additional pin-hole diaphragm 18 prevents neighboring light transmitters 12′ from transmitting light through one and the same aperture of the diaphragm. In this manner, neighboring beams are kept separated from each other and only properly directionalized light beams can exit the transmitter bar, which is demonstrated by diverging beam 20, which is blocked off in the desired manner by the second pin-hole diaphragm and prevented from exiting past first diaphragm 14.

1. A transmitting element for light barriers and light grids comprising a light source and an optical arrangement for directionalizing light emitted by the light source and limiting an angular divergence of the light exiting the transmitting element, the light source having a light emitting surface with linear dimensions of less than 500 μm, the optical arrangement including a pin-hole diaphragm with an aperture having a linear aperture dimension of less than 3 mm, a distance between the pin-hole diaphragm and the emitting surface in a direction of the emitted light being at least 5 mm.

2. A transmitting element according to claim 1 wherein a distance between the pin-hole diaphragm and the emitting surface is less than 40 mm.

3. A transmitting element according to claim 2 wherein a distance between the pin-hole diaphragm and the emitting surface is between about 10 mm and about 30 mm.

4. A transmitting element according to claim 3 wherein the distance between the pin-hole diaphragm and the emitting surface is about 20 mm.

5. A transmitting element according to claim 1 wherein the aperture in the pin-hole diaphragm is a circular aperture having a diameter of less than 3 mm.

6. A transmitting element according to claim 4 wherein the diameter of the aperture in the pin-hole diaphragm is about 1.5 mm.

7. A transmitting element according to claim 1 wherein the light-emitting surface of the light source has linear dimensions of less than 400 μm.

8. A transmitting element according to claim 7 wherein the light emitting surface of the light source has linear dimensions of less than 200 μm.

9. A transmitting element according to claim 1 wherein the light source comprises a semiconductor element.

10. A transmitting element according to claim 9 wherein the light source comprises an LED or a laser diode.

11. A transmitting element according to claim 1 wherein the light source comprises a VCSEL laser diode.

12. A transmitting element according to claim 9 wherein the semiconductor element of the light source is arranged as at least one of a chip on a housing wall of the transmitting element, a COB arrangement and a COF arrangement

13. A transmitting element according to claim 1 including a transparent cover placed over the light source and the pin-hole diaphragm at a light exit side of the transmitting element.

14. A transmitting element according to claim 1 including an additional pin-hole diaphragm arranged between the light source and the first-mentioned pin-hole diaphragm.

15. A light barrier comprising a transmitting element including a light source and an optical arrangement for directionalizing light emitted by the light source and limiting an angular divergence of the light exiting the transmitting element, the light source having a light emitting surface with linear dimensions of less than 500 μm, the optical arrangement including a pin-hole diaphragm with an aperture having a linear aperture dimension of less than 3 mm, a distance between the pin-hole diaphragm and the emitting surface in a direction of the emitted light being at least 5 mm.
